(19) United States
(12) Patent Application Publication
(10) Pub. No.: US 2010/0078110 A1
(43) Pub. Date: Apr. 1, 2010

(54) PNEUMATIC TIRE

(76) Inventors: Paul Harry Sandstrom, Cuyahoga Falls, OH (US); Ping Zhang, Hudson, OH (US); Xiaoping Yang, Streetsboro, OH (US); Joseph John Kulig, Tallmadge, OH (US); Aaron Scott Puhala, Kent, OH (US); Rebecca Lee Dando, Uniontown, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/241,472

(22) Filed: Sep. 30, 2008

(51) Int. Cl. B60C 1/00; C08K 3/34

(52) U.S. Cl. 152/510; 524/445; 152/525; 152/564; 152/547

(57) ABSTRACT

The present invention is directed to a pneumatic tire comprising at least one component, the at least one component comprising a rubber composition, the rubber composition comprising
from about 50 to about 100 parts by weight, per 100 parts by weight of elastomer, of a vinylpyridine-styrene-butadiene (VPSBR) elastomer comprising units derived from monomers comprising styrene, 1,3-butadiene, and vinylpyridine monomers which have the structural formula:

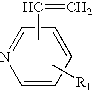

wherein R₁ represents a hydrogen atom or a straight chain or branched alkyl group containing 1 to 4 carbon atoms, wherein the VPSBR comprises from about 0.1 to about 8 percent by weight of vinylpyridine monomer;
from 0 to about 50 phr of at least one additional diene-based elastomer;
from about 5 to about 15 phr of an at least partially exfoliated clay; and
from about 1 to about 40 phr of a polyoctenamer.

### BACKGROUND OF THE INVENTION

A combination of nanoclay with a functionalized ESBR through a masterbatching process leads to rubber compositions with good abrasion resistance and low hysteresis. However, the processability of these rubber compositions is not as good as rubber compositions based on carbon black, perhaps mostly due to strong polymer-filler interaction in the uncured state. It is therefore desirable to improve the processibility and to further enhance the abrasion resistance of the clay nanocomposite rubber composition in order to take advantage of the good hysteresis property and other cured properties of such rubber composition.

### SUMMARY OF THE INVENTION

The present invention is directed to a pneumatic tire comprising at least one component, the at least one component comprising a rubber composition, the rubber composition comprising
from about 50 to about 100 parts by weight, per 100 parts by weight of elastomer, of a vinylpyridine-styrene-butadiene (VPSBR) elastomer comprising units derived from monomers comprising styrene, 1,3-butadiene, and vinylpyridine monomers which have the structural formula:

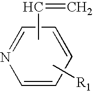

wherein R₁ represents a hydrogen atom or a straight chain or branched alkyl group containing 1 to 4 carbon atoms, wherein the VPSBR comprises from about 0.1 to about 8 percent by weight of vinylpyridine monomer;
from 0 to about 50 phr of at least one additional diene-based elastomer;
from about 5 to about 15 phr of an at least partially exfoliated clay; and
from about 1 to about 40 phr of a polyoctenamer.

### DETAILED DESCRIPTION OF THE INVENTION

There is disclosed a pneumatic tire comprising at least one component, the at least one component comprising a rubber composition, the rubber composition comprising
from about 50 to about 100 parts by weight, per 100 parts by weight of elastomer, of a vinylpyridine-styrene-butadiene (VPSBR) elastomer comprising units derived from monomers comprising styrene, 1,3-butadiene, and vinylpyridine monomers which have the structural formula:

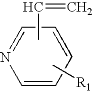

wherein R₁ represents a hydrogen atom or a straight chain or branched alkyl group containing 1 to 4 carbon atoms, wherein the VPSBR comprises from about 0.1 to about 8 percent by weight of vinylpyridine monomer;
from 0 to about 50 phr of at least one additional diene-based elastomer;
from about 5 to about 15 phr of an at least partially exfoliated clay; and
from about 1 to about 40 phr of a polyoctenamer.

In one embodiment, the vinylpyridine monomer may be selected from 2-vinylpyridine, 3-vinylpyridine, 4-vinylpyridine, 6-methyl-2-vinylpyridine, 6-methyl-3-vinylpyridine, 5-methyl-2-vinylpyridine and 5-ethyl-2-vinylpyridine, and mixtures thereof. Of these 4-vinylpyridine is preferred.

Clays considered for use in this invention are clays which, prior to combination with the VPSBR, are composed of a plurality of stacked platelets (e.g., very thin silicate based platelets) which contain cationically exchangeable ions in the galleries between such platelets. Representative of such clays are water swellable smectite clays, vermiculite based clays and mica based clays. Included are both naturally occurring clays and synthetic clays. Also included in suitable clays include sepiolite and attapulgite clays. Suitable synthetic clays include the Laponite® clays from Southern Clay Products. Preferably such water-swellable clays are smectite clays. Representative of smectite clays are, for example, montmorillonite, hectorite, nontrite, beidellite, volkonskoite, saponite, sauconite, sobockite, sterensite, and sinfordite clays of which montmorillonite and hectorite clays are preferred.

In one embodiment, the VPSBR and clay are combined as a masterbatch prepared following the methods of Ser. No. 11/641,513, published as U.S. 2008/0146719, fully incorporated herein by reference. As taught therein, a dispersion of at least partially exfoliated clay particles in an elastomer is provided by blending a water slurry of water-swellable multilayered clay (e.g., a smectite clay) with an emulsion latex of anionic (negatively charged) vinylpyridine-styrene-butadiene (VPSBR) terpolymer elastomer particles having a pH in a range of about 6 to about 11, preferably about 7 to about 10, and thereafter lowering the pH of the mixture to protonate the VPSBR to effect an ion exchange by the protonated vinylpyridine of the VPSBR with cationically exchangeable ion(s) contained within the galleries of the stacked platelets of the clay and thereby delaminate the clay and cause at least a partial exfoliation of the clay into individual clay platelets, and to coagulate the latex, all in situ. In practice, a small amount of acid, or salt/acid combination, is added to reduce the pH of the emulsion to a value, for example, in a range of from about 1 to about 4, preferably to about 1 to about 2, to aid in coagulating (precipitating) the elastomer particles and at least partially exfoliated clay as a nanocomposite.

The masterbatch may then simply be recovered by drying the coagulant, or precipitate.

In practice, the anionic (negatively charged) VPSBR elastomer particles may be formed, for example, by use of anionic surfactant(s) to stabilize the emulsion. Such use of anionic surfactants for such purpose is well known to those having skill in such art.

In practice, an acid, or salt/acid combination, often is used to reduce the pH of an anionic latex from a pH, for example, in a range of about 6 to about 11 to a more acidic value in a range of, for example, of about 1 to about 4 to therefore promote protonation of the VPSBR units derived from vinylpyridine monomer and consequent delamination of the clay, and a destabilization of the emulsion and promoting a coagulation, or precipitation, of the elastomer particles from the emulsion. A representative example of an acid, or salt/acid combination, for such purpose is, for example, sulfuric acid or a combination of sodium chloride and sulfuric acid.

Further, the aforesaid use of an acid, or salt/acid combination, can be beneficially used to aid in the coagulation process by reduction of the pH of the VPSBR emulsion/clay mixture while also inducing delamination of the clay by the consequently protonated VPSBR units derived from vinylpyridine monomer.

Accordingly, this invention is considered herein to be a significant departure from past practice by use of anionic VPSBR elastomer particles and water swelled, water-swellable clay, together with an acid, or salt acid combination, to effect both a coagulation/precipitation of the elastomer/clay particle composite and an in situ formation of ionic bonding between the elastomer and partially exfoliated clay particles.

Therefore, a significant aspect of this invention is the delamination or exfoliation of the water-swelled clay contained in an anionic emulsion of VPSBR elastomer particles, wherein the water-swelled clay contains cationically exchangeable ions (e.g., sodium ion) within the galleries between its platelets and wherein the delamination is accomplished by protonating the VPSBR units derived from vinylpyridine monomer to effect an ion transfer between the ions within the clay galleries and the protonated VPSBR units derived from vinylpyridine monomer.

A further significant aspect of the invention is the substantially simultaneous precipitation (coagulation) of the elastomer which contained dispersion of the delaminated (and at least partially exfoliated) clay particles as a nanocomposite which is aided by the addition of the acidic water to destabilize the emulsion.

Another significant aspect of the invention is the strong association between the elastomer and the largely delaminated clay particles through the ionic bonding of vinylpyridine along the elastomer chains and clay surface. This ionic association provides strong interphase which ensures better load transfer and better mechanical properties.

In an additional departure from past practice, the water-swellable clay is introduced into the emulsion of anionic VPSBR elastomer particles in a pre-water swelled form but without being first intercalated with an intercalant (e.g., a non-pre-intercalated clay as being a water-swelled clay which is not first intercalated with a quaternary ammonium salt to effect an ion exchange prior to its addition to the emulsion) so that the protonation of the vinylpyridine of the VPSBR is relied upon to delaminate and exfoliate the water-swelled clay by the aforesaid ion exchange in situ within the emulsion of anionic elastomer particles.

For the practice of this invention, it is intended that the clay delamination and exfoliation process for this invention is conducted in the presence of the anionic (negatively charged) elastomer latex particles and to the exclusion of cationic elastomer particles contained in a cationic surfactant.

In a summary, then, the process of this invention differs significantly from past practice, at least in part because the water-swellable clay (e.g., smectite clay) is
(A) not intercalated during the polymerization of the monomers,
(B) not intercalated by physically blending the smectite clay with the elastomer after it has been coagulated and recovered as a dry elastomer,
(C) not intercalated by blending a smectite clay which has been pre-intercalated by treatment with a quaternary ammonium salt prior to blending the pre-intercalated clay with the elastomer, and
(D) strongly associated with elastomer matrix through ionic bonding with protonated vinylpyridine groups.

Indeed, while some elements of the process of this invention might appear to be somewhat simplistic in operational nature, it is considered herein that the overall technical procedural application is a significant departure from past practice.

In the description of this invention, the term “phr” is used to designate parts by weight of a material per 100 parts by weight of elastomer. The terms “rubber” and “elastomer” may be used interchangeably unless otherwise indicated. The terms “vulcanized” and “cured” may be used interchangeably, as well as “unvulcanized” or “uncured,” unless otherwise indicated.

In accordance with this invention, a process of preparing a masterbatch comprised of an elastomer and at least partially exfoliated water-swellable clay, (in situ within an elastomer host of anionic elastomer particles), comprises
(A) forming a first blend of water-swelled clay and anionic polymer particle emulsion by blending:
   (1) an aqueous mixture comprised of water and a multilayered water-swellable clay, exclusive of an intercalant for said clay (e.g., exclusive of a quaternary ammonium salt), wherein said water-swellable clay is comprised of a plurality of stacked platelets with water-expanded (swollen) galleries between said platelets, wherein said galleries contain naturally occurring cationically ion exchangeable ions therein, (e.g., montmorillonite clay which contains sodium ions within said galleries), and
   (2) an emulsion of anionic synthetic vinylpyridine-styrene-butadiene terpolymer (VPSBR) elastomer particles as an aqueous pre-formed elastomer emulsion having a pH in a range of from about 6 to about 11, preferably about 7 to about 10, comprised of anionic elastomer particles (elastomer particles having anions on the surface derived from an anionic surfactant) prepared by aqueous free radical induced polymerization of monomers in the presence of a free radical generating polymerization initiator and non-polymerizable anionic surfactant, wherein said synthetic elastomer particles are derived from an aqueous polymerization of a vinylpyridine monomer, styrene and 1,3-butadiene, and
(B) blending with said first blend an aqueous mixture comprised of water and inorganic acid having a pH in a range of about 1 to about 4.

Water-swellable clays considered for use in this invention which are clays composed of a plurality of stacked platelets (e.g., very thin silicate based platelets) which contain cationically exchangeable ions in the galleries between such platelets. Representative of such clays are water swellable smectite clays, vermiculite based clays and mica based clays. Included are both naturally occurring clays and synthetic clays. Also included in suitable clays include sepiolite and attapulgite clays. Suitable synthetic clays include the Laponite® clays from Southern Clay Products. Preferably such water-swellable clays are smectite clays. Representative of smectite clays are, for example, montmorillonite, hectorite, nontrite, beidellite, volkonskoite, saponite, sauconite, sobockite, sterensite, and sinfordite clays of which montmorillonite and hectorite clays are preferred. For various exemplary smectite clays, see for example U.S. Pat. No. 5,552,469. Such cationically exchangeable ions contained in such galleries are typically comprised of at least one of sodium ions and potassium ions, which may also include calcium ions and/or magnesium ions, although it is understood that additional cationically exchangeable ions may be present. Typically, montmorillonite clay is preferred which contains sodium ions in such galleries, although it is understood that a minor amount of additional cationically exchangeable ions may be contained in such galleries such as for example, calcium ions.

In one aspect, a water swellable clay, such as for example a smectite clay such as, for example, a montmorillonite clay, for use in this invention, might be described, for example, as a naturally occurring clay of a structure which is composed of a plurality of stacked, thin and relatively flat, layers, where such individual layers may be of a structure viewed as being composed of very thin octahedral shaped alumina layer sandwiched between two very thin tetrahedrally shaped silica layers to form an aluminosilicate structure. Generally, for such aluminosilicate structure in the naturally occurring montmorillonite clay, some of the aluminum cations (Al⁺³) are viewed as having been replaced by magnesium cations (Mg⁺²) which results in a net negative charge to the platelet layers of the clay structure. Such negative charge is viewed as being balanced in the naturally occurring clay with hydrated sodium, lithium, magnesium, calcium and/or potassium cations, usually primarily sodium ions, within the spacing (sometimes referred to as “galleries”) between the aforesaid aluminosilicate layers, or platelets.

In practice, the degree of exfoliation of the clay platelets can be qualitatively evaluated, for example, by wide angle X-ray diffraction (WAXD) as evidenced by a substantial absence of an X-ray peak which is a well known method of such evaluation. Such evaluation relies upon observing WAXD peak intensities and changes (increase) in the basal plane spacing between platelets.

In practice, preferably from about 0.1 to about 80, alternately about 5 to about 20, parts by weight of said water swelled clay is added to said anionic emulsion per 100 parts by weight of said elastomer particles, depending somewhat upon the nature of the clay including the cationically exchangeable ions within the galleries between the layers of the clay, and the VPSBR elastomer.

Accordingly, the resulting nanocomposite may contain about 0.1 to about 80, alternately about 5 to about 20, parts by weight of at least partially exfoliated clay particles per 100 parts by weight of the elastomer host.

It is to be appreciated that, in practice, a synthetic emulsion of anionic VPSBR elastomer particles may be prepared, for example, by emulsion polymerization of a vinylpyridine monomer, styrene and 1,3-butadiene monomers, in a water emulsion medium via a free radical polymerization in the presence of an anionic surfactant.

It is to be further appreciated that a VPSBR made by the process described herein comprises units derived from vinylpyridine monomer, styrene and 1,3-butadiene monomers, in the sense that upon incorporation into the VPSBR polymer chain, the VPSBR units derived from the monomers differ in structure somewhat from the monomers, owing to the polymerization reaction. Thus, reference herein to “units derived from monomers” and the like is understood to mean units incorporated into the VPSBR chain that have their origin in the vinylpyridine monomer, styrene and 1,3-butadiene monomers.

In further accordance with this invention, said monomers for said synthetic elastomer particles are derived from aqueous emulsion polymerization of vinylpyridine monomer, styrene and 1,3-butadiene monomers comprised of from about 0.1 to about 40, alternately about 15 to about 35, weight percent styrene monomer; from about 0.1 to about 8, alternately from about 0.5 to about 4, weight percent vinylpyridine monomer, and the balance 1,3 butadiene monomer.

In one embodiment, suitable vinylpyridine monomers have the structural formula:

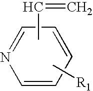

wherein R₁ represents a hydrogen atom or a straight chain or branched alkyl group containing 1 to 4 carbon atoms. In one embodiment, the vinylpyridine monomer may be selected from 2-vinylpyridine, 3-vinylpyridine, 4-vinylpyridine, 6-methyl-2-vinylpyridine, 6-methyl-3-vinylpyridine, 5-methyl-2-vinylpyridine and 5-ethyl-2-vinylpyridine, and mixtures thereof. Of these 4-vinylpyridine is preferred.

Representative examples of anionic surfactants for the preparation of the synthetic emulsion of anionic VPSBR elastomer particles may be found, for example, in McCutcheon's, Volume 1, “Emulsifiers & Detergents”, North American Edition, 2001, Pages 291 and 292, with representative examples of non-ionic surfactants shown on Pages 294 through 300 and examples of cationic surfactants shown on Pages 300 and 301.

For the practice of this invention, cationic surfactants for the preparation of the synthetic elastomer particles are to be excluded.

As hereinbefore described, in practice, the emulsion of anionic VPSBR elastomer particles may be prepared, for example, by a free radical polymerization of the monomers in a water-based medium in the presence of a free radical initiator and said anionic surfactant(s). A general description of an aqueous emulsion polymerization of styrene and 1,3-butadiene directed to an anionic surfactant (emulsifier) based polymerization, may be found, for example, in The Vanderbilt Rubber Handbook, 1978 Edition, Pages 55 through 61. A general description of the micelle-generating substances (emulsifiers, surfactants, soaps) is given in Emulsion Polymerization Theory and Practice by D. C. Blackley, 1975, Pages 251 through 328. It is to be understood that the procedures are fully applicable to the present VPSBR.

The use of various free radical generating initiators for aqueous emulsion of styrene/butadiene monomer systems to form styrene/butadiene elastomers is well known to those having skill in such art.

In practice, said free radical generating polymerization initiator for preparation of said synthetic elastomer particles may be selected from, for example,
(A) dissociative initiators, or
(B) redox initiators as described in the above referenced “Emulsion Polymerization Theory and Practice.”

Such free radical generating polymerization initiators are well known to those having skill in such art.

The practice of emulsion polymerization of SBR (and by extension, of VPSBR) may be classified into two types. The hot polymerization is based on dissociative initiators and is typically run at 50° C. to 70° C. The cold polymerization is based on redox initiators and is typically run at temperatures less than 10° C., preferably 5° C. The type of process sets the polymerization temperature. The polymerization temperature affects the macrostructure and microstructure. Emulsion SBR prepared via a hot polymerization will have a trans-1,4-butadiene content of 60 percent or less and higher branching. Emulsion SBR prepared via a cold process will have a higher trans-1,4-butadiene content and lower branching. The emulsion SBR from cold polymerization process will typically have an trans-1,4-butadiene content of greater than about 60 percent by weight, based on the polybutadiene content of the polymer. Therefore, in one embodiment, the trans-1,4-butadiene content of the VPSBR ranges from about 60 percent to about 80 percent by weight. In one embodiment, the trans-1,4-butadiene content of the VPSBR ranges from about 65 percent to about 75 percent. In one embodiment, the trans-1,4-butadiene content of the VPSBR ranges from about 68 percent to about 72 percent.

Higher trans-1,4 content in excess of about 72 percent in the VPSBR may be achieved using a cryogenic polymerization as disclosed for example in J. L. Binder, Ind. Eng. Chem. 46, 1727 (1954).

In one preferred embodiment, the free radical polymerization is a so-called “cold” polymerization, as opposed to a hot polymerization. The amount of free radical initiator used is sufficient to give a reasonable reaction rate, with monomer conversion up to about 60 to 65 percent in 6 hours. In contrast to the hot polymerization typically used commercially for RFL adhesive-type vinylpyridine-styrene-butadiene latexes with about 15 percent by weight of 2-vinylpyridine in the polymer, the cold polymerization results in a VPSBR with a lower amount of gel and branching resulting in desirable physical properties for the present tire application.

In practice, said inorganic acid for adding to said first blend may be selected from mineral acids such as for example, sulfuric acid, nitric acid, hydrochloric acid and phosphoric acid. Also, organic acids such as, for example, formic acid, and acetic acid may be used, although the mineral acids are preferred.

In practice, for said acid/salt combination, said aqueous mixture of water and acid, preferably an inorganic acid, may, if desired, also contain a water soluble salt selected from, for example, at least one of sodium chloride, potassium chloride, sodium sulfate, potassium sulfate, magnesium chloride, magnesium sulfate, aluminum sulfate, potassium carbonate and tripotassium phosphate.

In practice, said water for said aqueous mixture of water and water swellable clay is preferably provided in a de-mineralized form, or at least without an appreciable mineral content.

In practice, it is to be appreciated that the method of this invention may desirably rely, at least in part, on the use of the acid or salt/acid combination to aid in destabilizing the anionic emulsion and thereby coagulating/precipitating the anionic elastomer particles/clay particle mixture. At the same time, the acid or salt/acid combination acts to protonate the VPSBR units derived from vinylpyridine monomer, with subsequent ion exchange with cations in the clay by the protonated moiety to delaminate the clay.

In further accordance with this invention, a masterbatch is provided which is comprised of at least the VPSBR which contains a dispersion therein of at least partially exfoliated clay particles.

In additional accordance with this invention, a masterbatch comprised of an elastomer which contains a dispersion therein of said in situ formed partially exfoliated water swellable clay is provided as prepared by the process of this invention.

Accordingly, as hereinbefore discussed, said masterbatch may be comprised of, based on 100 parts by weight of the elastomer host, from about 0.1 to about 80, about 5 to about 80 or, alternately about 5 to about 20, parts by weight of said in situ formed at least partially exfoliated clay.

One component of the rubber composition is a polyoctenamer. Suitable polyoctenamer may include cyclic or linear macromolecules based on cyclooctene, or a mixture of such cyclic and linear macromolecules. Suitable polyoctenamer is commercially available as Vestenamer 8012 or V6213 from Degussa AG High Performance Polymers. Vestenamer is a polyoctenamer produced in a methathesis reaction of cyclooctene. In one embodiment, the octenamer may have a weight averaged molecular weight of about 90,000 to about 110,000; a glass transition temperature of from about −65° C. to about −75° C.; a crystalline content of from about 10 to about 30 percent by weight; a melting point of from about 36° C. to about 54° C.; a thermal decomposition temperature of from about 250° C. to about 275° C.; a cis/trans ratio of double bonds of from about 20:80 to about 40:60; and Mooney viscosity ML 1+4 of less than 10.

In one embodiment, polyoctenamer is added in an amount ranging from about 1 to about 40 percent by weight of the total rubber or elastomer used in the rubber composition, or about 1 to about 40 phr (parts per hundred rubber). For example, 1 to 40 phr polyoctenamer may be used along with 100 phr of at least one other elastomer. Alternatively, from about 5 phr to about 30 phr polyoctenamer is added to the rubber composition.

The rubber composition may be used with additional rubbers or elastomers containing olefinic unsaturation. The phrases “rubber or elastomer containing olefinic unsaturation” or “diene-based elastomer” are intended to include both natural rubber and its various raw and reclaim forms as well as various synthetic rubbers. In the description of this invention, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred additional diene-based elastomers are polyisoprene (natural or synthetic), polybutadiene and SBR.

In one embodiment, the rubber composition comprises from 0 to 50 phr of at least one additional diene-based elastomer.

In one aspect of this invention, an emulsion polymerization derived styrene/butadiene (E-SBR) might be used having a relatively conventional styrene content of about 20 to about 28 percent bound styrene or, for some applications, an E-SBR having a medium to relatively high bound styrene content, namely, a bound styrene content of about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

In one embodiment, c is 1,4-polybutadiene rubber (BR) may be used. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having skill in the rubber art.

The term “phr” as used herein, and according to conventional practice, refers to “parts by weight of a respective material per 100 parts by weight of rubber, or elastomer.”

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

The rubber composition may include from about 10 to about 150 phr of silica. In another embodiment, from 20 to 80 phr of silica may be used.

The commonly employed siliceous pigments which may be used in the rubber compound include conventional pyrogenic and precipitated siliceous pigments (silica). In one embodiment, precipitated silica is used. The conventional siliceous pigments employed in this invention are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930).

The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Commonly employed carbon blacks can be used as a conventional filler in an amount ranging from 10 to 150 phr. In another embodiment, from 20 to 80 phr of carbon black may be used. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Other fillers may be used in the rubber composition including, but not limited to, particulate fillers including ultra high molecular weight polyethylene (UHMWPE), crosslinked particulate polymer gels including but not limited to those disclosed in U.S. Pat. No. 6,242,534; 6,207,757; 6,133,364; 6,372,857; 5,395,891; or 6,127,488, and plasticized starch composite filler including but not limited to that disclosed in U.S. Pat. No. 5,672,639. Such other fillers may be used in an amount ranging from 1 to 30 phr.

In one embodiment the rubber composition may contain a conventional sulfur containing organosilicon compound. Examples of suitable sulfur containing organosilicon compounds are of the formula:

Z-Alk-Sₙ-Alk-Z III

in which Z is selected from the group consisting of

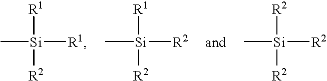

where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

In one embodiment, the sulfur containing organosilicon compounds are the 3,3′-bis(trimethoxy or triethoxy silylpropyl) polysulfides. In one embodiment, the sulfur containing organosilicon compounds are 3,3′-bis(triethoxysilylpropyl) disulfide and/or 3,3′-bis(triethoxysilylpropyl) tetrasulfide. Therefore, as to formula III, Z may be

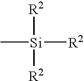

where R² is an alkoxy of 2 to 4 carbon atoms, alternatively 2 carbon atoms; alk is a divalent hydrocarbon of 2 to 4 carbon atoms, alternatively with 3 carbon atoms; and n is an integer of from 2 to 5, alternatively 2 or 4.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include those disclosed in U.S. Patent Publication No. 2003/0130535. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The rubber composition may be incorporated in a variety of rubber components of the tire. For example, the rubber component may be a tread (including tread cap and tread base), sidewall, apex, chafer, sidewall insert, wirecoat or innerliner. In one embodiment, the component is a tread.

The pneumatic tire of the present invention may be a race tire, passenger tire, aircraft tire, agricultural, earthmover, off-the-road, truck tire, and the like. In one embodiment, the tire is a passenger or truck tire. The tire may also be a radial or bias.

Vulcanization of the pneumatic tire of the present invention is generally carried out at conventional temperatures ranging from about 100° C. to 200° C. In one embodiment, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The invention is further illustrated by the following nonlimiting example.

### Example 1

In this example, the effect of adding a polyoctenamer to a VPSBR/clay nanocomposite masterbatch is illustrated. Rubber compositions were prepared for evaluating the effect of introducing a small quantity of polyoctenamer into the clay nanocomposite rubber composition. The rubber compositions were prepared by mixing the ingredients in two sequential non-productive (NP) and productive (PR) mixing steps in an internal rubber mixer. The dump temperature for NP was 170° C. The dump temperature for PR was 120° C. Polyoctenamer was introduced during the non-productive stage of mixing.

The basic recipe for the rubber samples is presented in the following Table 1 and recited in parts by weight unless otherwise indicated.

TABLE 1

Parts

Non-Productive Mixing Step (NP1), (mixed to about 170° C.)

| | |
|---|---|
| 4VP ESBR/7.5 phr clay masterbatch¹ | Variable |
| 4VP ESBR/10 phr clay masterbatch² | Variable |
| Polyoctenamer³ | Variable |
| Silane coupling agent⁴ | Variable |
| Wax and protective agents | 3.5 |
| Stearic acid | 3 |
| Zinc oxide | 3 |

Productive Mixing Step (PR), (mixed to about 120° C.)

| | |
|---|---|
| Sulfur | 1.5 |
| Sulfenamide based cure accelerator | 1.2 |
| Antioxidant | 0.75 |
| Thiuram based cure accelerator | 0.13 |

¹ESBR functionalized with 2.5 percent by weight 4-vinylpyridine (4-VP)/7.5 phr clay masterbatch prepared following procedures as outlined in US Patent Application No. 2008/0146719 from Goodyear Tire & Rubber Co.
²ESBR functionalized with 2.5 percent by weight 4-vinylpyridine (4-VP)/10 phr clay masterbatch prepared following procedures as outlined in US Patent Application No. 2008/0146719 from Goodyear Tire & Rubber Co.
³Polyoctenamer commercially known as Vestenamer 8012 with a melting point of 54° C. from the Degussa Company
⁴A 50/50 blend of carbon black N330 and disulfide silane coupling agent commercially known as X266S from the Degussa Company

The following Table 2 illustrates processing characteristics and various physical properties of rubber compositions based upon the basic recipe of Table 1.

Samples A and D are comparative rubber samples containing 4-VP ESBR/7.5 phr clay masterbatch (4VP ESBR/7.5 MB) and 4-VP ESBR/10 phr clay masterbatch (4VP ESBR/10 MB), respectively. Experimental rubber samples B and C contain 5 and 10 phr of polyoctenamer, respectively, with sample A being the comparative sample. Experimental rubber samples E and F contain 5 and 10 phr of polyoctenamer, respectively, with sample D being the comparative sample.

It can be seen from Table 2 that the comparative rubber samples A and D containing 4-VP ESBR/clay nanocomposite exhibited undesirable processing characteristics as indicated from the relatively high uncured modulus G' of 0.226 and 0.255 MPa, respectively. The introduction of polyoctenamer into the 4-VP ESBR nanocomposite rubber composition led to reduced uncured modulus G', indicative of improved processibility of the rubber composition. Surprisingly, the abrasion resistance performance of the rubber composition, measured from the DIN abrasion as well as from the Grosch abrasion, was significantly enhanced from the use of polyoctenamer as shown from the comparison of Experimental rubber samples B, C, E and F with the comparative samples A and D, while the compound properties associated with tire rolling resistance and compound heat build up, such as tan delta at high temperature and rebound were not significantly negatively affected. Other desirable compound properties, such as dynamic and static stiffness and Shore A hardness were essentially maintained or improved.

TABLE 2

| | A | B | C | D | E | F |
|---|---|---|---|---|---|---|
| 4VP ESBR/7.5 MB (phr) | 107.5 | 107.5 | 107.5 | 0 | 0 | 0 |
| 4VP ESBR/10 MB (phr) | 0 | 0 | 0 | 110 | 110 | 110 |
| X75S (phr) | 1.2 | 1.2 | 1.2 | 1.6 | 1.6 | 1.6 |
| Vestenamer 8012 (phr) | 0 | 5 | 10 | 0 | 5 | 10 |
| Rheometer¹, 150° C. | | | | | | |
| Maximum torque (dNm) | 12.94 | 12.26 | 12.04 | 12.99 | 12.13 | 11.58 |
| Minimum torque (dNm) | 1.87 | 1.65 | 1.58 | 2.23 | 2.07 | 1.88 |
| Delta torque (dNm) | 11.04 | 10.61 | 10.46 | 10.76 | 10.05 | 9.70 |
| T90 (minutes) | 12.43 | 13.22 | 15.09 | 23.93 | 26.10 | 28.15 |
| RPA Analysis, 100° C. | | | | | | |
| Uncured G′ at 15% strain, MPa | 0.226 | 0.194 | 0.187 | 0.255 | 0.238 | 0.214 |
| G′ at 1% strain, MPa | 1.20 | 1.10 | 1.08 | 1.20 | 1.16 | 1.09 |
| G′ at 10% strain, MPa | 1.01 | 0.94 | 0.92 | 0.91 | 0.87 | 0.83 |
| Tan delta at 10% strain | 0.059 | 0.063 | 0.066 | 0.092 | 0.095 | 0.098 |
| Stress-strain, ATS, 16 min, 160° C.² | | | | | | |
| Tensile strength (MPa) | 16.6 | 13.6 | 14.2 | 17.5 | 15.0 | 11.8 |
| Elongation at break (%) | 364 | 351 | 394 | 365 | 321 | 269 |
| 100% modulus (MPa) | 2.8 | 2.7 | 2.8 | 3.2 | 3.2 | 3.5 |
| 300% modulus (MPa) | 14.9 | 12.7 | 11.9 | 15.8 | 15.5 | |
| Rebound | | | | | | |
| 23° C. | 56.5 | 56.0 | 55.3 | 54.2 | 55.3 | 55.1 |
| 100° C. | 70.6 | 69.2 | 66.9 | 66.8 | 66.7 | 65.2 |
| Shore A Hardness | | | | | | |
| 23° C. | 65 | 66 | 67 | 68 | 69 | 70 |
| 100° C. | 57 | 57 | 55 | 60 | 58 | 57 |
| DIN Abrasion Vol. Loss, 23° C. | 91 | 80 | 50 | 89 | 78 | 54 |
| Grosch Loss Rate, 23° C., mg/km | 493 | 422 | 361 | 441 | 405 | 367 |

¹Data according to Rubber Process Analyzer as RPA 2000 ™ instrument by Alpha Technologies, formerly of the Flexsys Company and formerly of the Monsanto Company. References to an RPA 2000 instrument may be found in the following publications: H. A. Palowski, et al, Rubber World, June 1992 and January 1997, as well as Rubber & Plastics News, April 26 and May 10, 1993.
²Data according to Automated Testing System instrument by the Instron Corporation which incorporates six tests in one system. Such instrument may determine ultimate tensile, ultimate elongation, moduli, etc. Data reported in the Table is generated by running the ring tensile test.

This example demonstrates the desirability and benefits of the use of polyoctenamer in a clay nanocomposite and a tire for enhanced compound abrasion resistance and processibility without significant compromise in other desirable compound properties.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire comprising at least one component, the at least one component comprising a rubber composition, the rubber composition comprising
from about 50 to about 100 parts by weight, per 100 parts by weight of elastomer, of a vinylpyridine-styrene-butadiene (VPSBR) elastomer comprising units derived from monomers comprising styrene, 1,3-butadiene, and vinylpyridine monomers which have the structural formula: 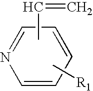
wherein R₁ represents a hydrogen atom or a straight chain or branched alkyl group containing 1 to 4 carbon atoms, wherein the VPSBR comprises from about 0.1 to about 8 percent by weight of vinylpyridine monomer;
from 0 to about 50 phr of at least one additional diene-based elastomer;
from about 5 to about 15 phr of an at least partially exfoliated clay; and
from about 1 to about 40 phr of a polyoctenamer.

2. The pneumatic tire of claim 1, wherein the vinylpyridine monomer comprises a member selected from the group consisting of 2-vinylpyridine, 3 vinylpyridine, 4-vinylpyridine, 6-methyl-2-vinylpyridine, 6-methyl-3-vinylpyridine, 5-methyl-2-vinylpyridine and 5-ethyl-2-vinylpyridine, and mixtures thereof.

3. The pneumatic tire of claim 1, wherein the vinylpyridine monomer comprises 4-vinylpyridine.

4. The pneumatic tire of claim 1, wherein the VPSBR comprises from about 0.5 to about 4 percent by weight of units derived from vinylpyridine monomer.

5. The pneumatic tire of claim 1, wherein the VPSBR comprises from about 0.5 to about 2 percent by weight of units derived from vinylpyridine monomer.

6. The pneumatic tire of claim 1, wherein the rubber composition further comprises from about 10 to about 100 phr of a filler selected from silica and carbon black.

7. The pneumatic tire of claim 1, wherein the VPSBR comprises from about 60 percent to about 80 percent by weight of trans-1,4-butadiene, based on the polybutadiene content of the VPSBR.

8. The pneumatic tire of claim 1, wherein the VPSBR comprises from about 65 percent to about 75 percent by weight of trans-1,4-butadiene, based on the polybutadiene content of the VPSBR.

9. The pneumatic tire of claim 1, wherein the VPSBR comprises from about 68 percent to about 72 percent by weight of trans-1,4-butadiene, based on the polybutadiene content of the VPSBR.

10. The pneumatic tire of claim 1 wherein the clay is selected from the group consisting of montmorillonite, hectorite, nontrite, beidellite, volkonskoite, saponite, sauconite, sobockite, sterensite, sinfordite, sepiolite, attapulgite, and synthetic clays.

11. The pneumatic tire of claim 1, wherein the at least one additional diene-based elastomer is selected from the group consisting of cis 1,4-polyisoprene (natural and synthetic), c is 1,4-polybutadiene, styrene/butadiene copolymers (aqueous emulsion polymerization prepared and organic solvent solution polymerization prepared), vinyl polybutadiene having a vinyl 1,2-content in a range of about 15 to about 90 percent, isoprene/butadiene copolymers, and styrene/isoprene/butadiene terpolymers.

12. The pneumatic tire of claim 1, wherein the component is selected from the group consisting of tread, sidewall, apex, sidewall insert, innerliner, and carcass.
